(19) United States
(12) Patent Application Publication
(10) Pub. No.: US 2007/0200674 A1
(43) Pub. Date: Aug. 30, 2007

(54) Electronic device having a location-based security feature

(75) Inventors: Ryan T. Moore, Overland Park, KS (US); Scott T. Moore, Olathe, KS (US); Jay D. Schroeder, Olathe, KS (US)

Correspondence Address: GARMIN LTD.;C/O GARMIN INTERNATIONAL, INC., ATTN: Legal - IP, 1200 EAST 151ST STREET, OLATHE, KS, 66062, US

(73) Assignee: GARMIN LTD., a Cayman Islands corporation

(21) Appl. No.: 11/353,617

(22) Filed: Feb. 14, 2006

(51) Int. Cl. H04L 9/32

(52) U.S. Cl. 340/5.74; 340/825.49; 701/208; 713/186; 340/5.52

(57) ABSTRACT

Embodiments of the present invention provide an electronic device having a location-based security feature. The device is generally operable to provide a primary security feature corresponding to a user input and provide a secondary security feature corresponding to a geographic security location of the electronic device. In various embodiments, the secondary security feature is operable to override the primary security feature. Such a configuration enables the secondary security feature to be satisfied independent of the user input.

### BACKGROUND OF THE INVENTION

1. Field of the Invention

The present invention relates to electronic devices. More particularly, the invention relates to an electronic device, such as a navigation device, having a security feature corresponding to a current geographic location of the device.

2. Description of the Related Art

Navigation devices are becoming increasingly popular due to their many beneficial features. For example, navigation devices commonly utilize the Global Positioning System (GPS) to calculate an accurate current geographic location based on received GPS signals. Due to this ability, navigation devices are commonly utilized by users in innumerable situations, including walking, exercising, biking, driving, boating, flying, etc. Unfortunately, the popularity and diverse use of navigation devices often leads to theft.

### SUMMARY OF THE INVENTION

The present invention solves the above-described problems and provides a distinct advance in the art of electronic devices. More particularly, the invention provides an electronic device, such as a navigation device, having a security feature corresponding to a geographic location. Such a configuration enables the location-based security feature to be satisfied independent of user input. In one embodiment, the present invention is a method of securing an electronic device. The method generally includes providing a primary security feature corresponding to a user input and providing a secondary security feature corresponding to a current geographic location of the electronic device. The secondary security feature may be operable to override the primary security feature and satisfied by comparing the current geographic location of the electronic device to a previously determined geographic security location.

In another embodiment, the present invention is an electronic device comprising a location determining component operable to determine a current geographic location of the electronic device, a user interface operable to receive a user input, and a processor coupled with the location determining component and the user interface. The processor is generally operable to provide a primary security feature corresponding to the user input and provide a secondary security feature corresponding to the current geographic location of the electronic device.

In another embodiment, the present invention is a navigation device comprising a location determining component operable to determine a current geographic location of the navigation device, a user interface operable to receive a user input, a memory, and a processor coupled with the location determining component, the user interface, and the memory. The processor is generally operable to provide a primary security feature corresponding to the user input, define a geographic security location and store the geographic security location within the memory, and provide a secondary security feature corresponding to the geographic security location. The secondary security feature is operable to override the primary security feature when the current geographic location of the navigation device is in proximity to the geographic security location.

In another embodiment, the present invention is a computer program for securing an electronic device. The computer program is stored within a memory for operating the electronic device. The computer program generally includes a code segment operable to provide a primary security feature corresponding to a user input and a code segment operable to provide a secondary security feature corresponding to a current geographic location of the electronic device.

Other aspects and advantages of the present invention will be apparent from the following detailed description of the preferred embodiments and the accompanying drawing figures.

### BRIEF DESCRIPTION OF THE DRAWING FIGURES

A preferred embodiment of the present invention is described in detail below with reference to the attached drawing figures, wherein:

FIG. 1 is a front view of an electronic device configured in accordance with various preferred embodiments of the present invention;

FIG. 2 is a block diagram of certain components of the electronic device of FIG. 1;

FIG. 3 is a sample screen display of the electronic device of FIGS. 1-2, the sample screen display showing a device configuration menu;

FIG. 4 is a sample screen display of the electronic device of FIGS. 1-3, the sample screen display showing a security configuration menu;

FIG. 5 is a sample screen display of the electronic device of FIGS. 1-4; the sample screen display showing a user access input screen;

FIG. 6 is a sample screen display of the electronic device of FIGS. 1-5; the sample screen display showing a user access input confirmation screen;

FIG. 7 is a sample screen display of the electronic device of FIGS. 1-6; the sample screen display showing a geographic security location information screen;

FIG. 8 is a sample screen display of the electronic device of FIGS. 1-7; the sample screen display showing a geographic security location input screen;

FIG. 9 is a flow chart showing some of the steps that may be performed by the electronic device of FIGS. 1-8; and

FIG. 10 is schematic diagram of a Global Positioning System (GPS) that may be utilized by various embodiments of the present invention.

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE PREFERRED EMBODIMENTS

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

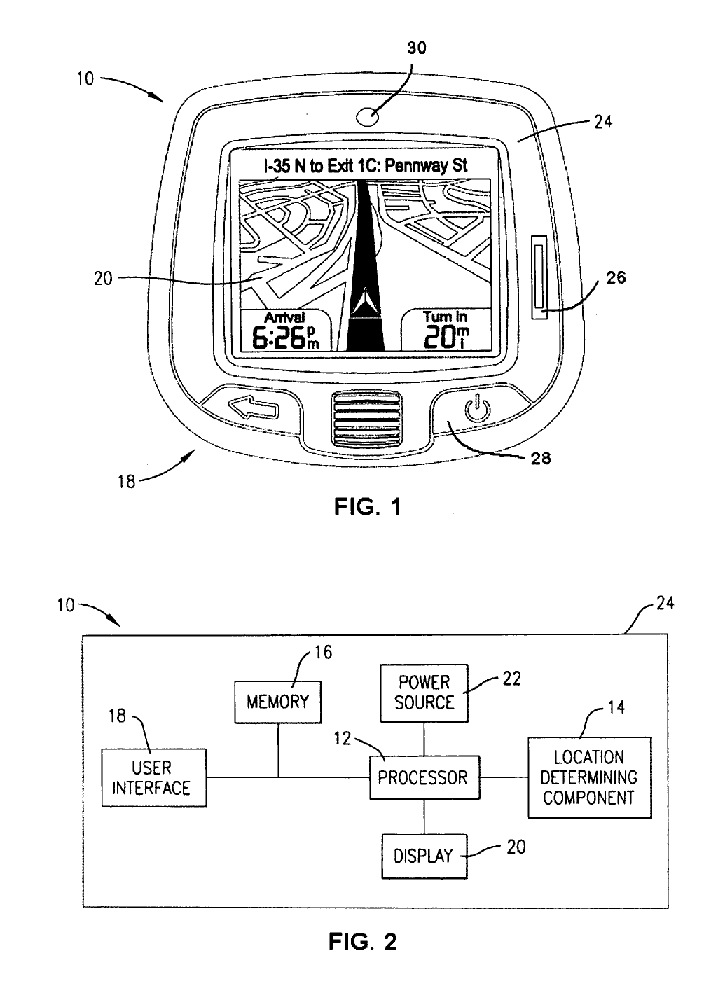

As shown in FIGS. 1-2, the present invention is preferably implemented utilizing a navigation device 10. The device 10 may be any electronic device operable to receive, utilize, or determine geographic information, such as a current geographic location. Thus, the device 10 may include computers, televisions, radios, portable computing devices such as laptops or personal data assistants (PDAs), cellular telephones, portable entertainment devices, etc. More preferably, the device 10 is a navigation device manufactured by GARMIN INTERNATIONAL, INC. of Olathe, Kans. However, the device 10 may be any device configured as described herein or otherwise operable to perform the functions described below.

The device 10 preferably includes a processor 12, a location determining component 14 coupled with the processor 12 to facilitate determination of a current geographic location, a memory 16 coupled with the processor 12 and operable to store information, a user interface 18 coupled with the processor 12 and operable to communicate with a user, a display 20 and power source 22 each coupled with the processor 12, and a housing 24 for housing the various components of the device 10.

The processor 12 is preferably coupled with the user interface 18, location determining component 14, memory 16, and display 20, through wired or wireless connections, such as a data bus, to enable information to be exchanged between the various elements. Further, the processor 12 is preferably operable to control the various functions of the device 10 according to a computer program, including one or more code segments, or other instructions associated with the memory 16 or with various processor logic and structure. The processor 12 may comprise various computing elements, such as integrated circuits, microcontrollers, microprocessors, programmable logic devices, etc, alone or in combination, to perform the operations described herein.

As described below in more detail, the processor 12 may determine a current geographic location of the device 10 by receiving the geographic location from the location determining component 14 or from another device through the user interface 18. Alternatively, the processor 12 may independently determine geographic location based on information and/or data, such as received navigation signals, provided by the location determining component 14, stored within the memory 16, or acquired from other devices or elements.

The location determining component 14 is coupled with the processor 12 to facilitate determination of geographic locations including a current location of the device 10. The location determining component 14 is not required in all embodiments as the processor 12 may retrieve geographic information from other sources such as the user interface 18 or through internal data stored within the memory 16. However, the location determining component 14 is preferably coupled with the processor 12 to enable rapid and accurate geographic location determination.

The location determining component 14 is preferably a global positioning system (GPS) receiver, and is adapted to provide, in a substantially conventional manner, geographic location information for the device 10. The location determining component 14 may be, for example, a GPS receiver much like those disclosed in U.S. Pat. No. 6,434,485, which is incorporated herein by specific reference. However, the location determining component 14 may receive cellular or other positioning signals utilizing various methods to facilitate determination of geographic locations without being limited to GPS.

As is known in the art, the GPS is a satellite-based radio navigation system capable of determining continuous position, velocity, time, and direction information for an unlimited number of users. Formally known as NAVSTAR, the GPS incorporates a plurality of satellites that orbit the earth in extremely precise orbits. Based on these precise orbits, GPS satellites can relay their location to any number of receiving units.

The location determining component 14 may scan radio frequencies for GPS satellite signals and, upon receiving a radio signal from a GPS satellite, determine the precise location of that satellite via one of different conventional methods. The location determining component 14 will continue scanning for signals until it has acquired at least three different satellite signals. Implementing geometrical triangulation, the location determining component 14 utilizes the three known positions to determine its own two-dimensional position relative to the satellites. Acquiring a fourth satellite signal will allow the location determining component 14 to calculate its three-dimensional position by the same geometrical calculation. As should be appreciated, the processor 12 may be operable to perform one or more of these functions, such as triangulation, in place of the location determining component 14.

Although GPS enabled devices are often used to describe navigational devices, it will be appreciated that satellites need not be used to determine a geographic position of a receiving unit since any receiving device capable of receiving the location from multiple transmitting locations can perform basic triangulation calculations to determine the relative position of the receiving device with respect to the transmitting locations. For example, cellular towers or any customized transmitting radio frequency towers can be used instead of satellites. With such a configuration, any standard geometric triangulation algorithm can be used to determine the exact location of the receiving unit.

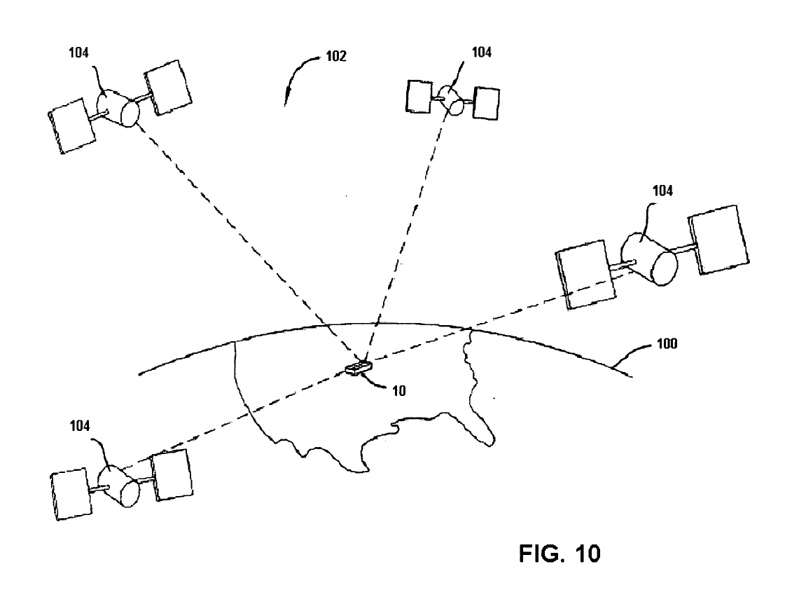

FIG. 10 shows one representative view of a GPS denoted generally by reference numeral 102. A plurality of satellites 104 are in orbit about the Earth 100. The orbit of each satellite is not necessarily synchronous with the orbits of other satellites and, in fact, is likely asynchronous. The navigation device 10, including the location determining component 14, is shown receiving spread spectrum GPS satellite signals from the various satellites 104.

The location determining component 14 may also include various processing and memory elements to determine the geographic location of the device 10 itself or it may provide information to the processor 12 to enable the processor 12 to specifically determine the geographic location of the device 10. Thus, the location determining component 14 need not itself calculate the current geographic location of the device 10 based upon received signals. The location determining component 14 also may include an antenna for receiving signals, such as a GPS patch antenna or helical antenna.

Further, the location determining component 14 may be integral with the processor 12 and/or memory 16 such that the location determining component 14 may be operable to specifically perform the various functions described herein, including steps 100-108. Thus, the processor 12 and location determining component 14 need not be separate or otherwise discrete elements.

In various embodiments the location determining component 14 need not directly determine the current geographic location of the device 10. For instance, the location determining component 14 may determine the current geographic location utilizing the user interface 18, such as by receiving location information from the user, through a network, from another electronic device, etc.

The memory 16 is coupled with the processor 12 and/or other device 10 elements and is operable to store various data utilized by the processor 12 and/or other elements. The memory 16 may include removable and non-removable memory elements such as RAM, ROM, flash, magnetic, optical, USB memory device, and/or other conventional memory elements.

Further, the memory 16 may comprise a portion of the user interface 18 to enable the user to provide information to the device 10 via the memory 16, such as by inserting a removable memory element into a slot 26 to provide information and instruction to the device 10. The slot 26 may be operable to conventionally receive the removable memory element and/or the slot 26 may be operable to receive a hardware key or other physically and/or electronically encoded device or locking element, as described below. The memory 16 may also be integral with the processor 12, such as in embodiments where the memory 16 comprises internal cache memory.

The memory 16 may store various data associated with operation of the device 10, such as a computer program, code segments, or other data for instructing the processor 12 and other device 10 elements to perform the steps described below. Further, the memory 16 may store various cartographic data corresponding to geographic locations including security locations, map data, and map elements, such as thoroughfares, terrain, alert locations, points of interest, and other general navigation data to facilitate the various navigation functions provided by the device 10. Additionally, the memory 16 may store destination addresses and previously calculated or otherwise acquired routes to various destination addresses for later retrieval by the processor 12.

Further, the various data stored within the memory 16 may be associated within a database to facilitate processor 12 retrieval of information. For example, the database may be configured to enable the processor 12 to retrieve geographic locations, map data, and related information based upon a current geographic location of the device 10, etc.

The user interface 18 enables users, third parties, or other devices to share information with the device 10. The user interface 18 is generally associated with the housing 24, such as by physical connection through wires, etc, or wirelessly utilizing conventional wireless protocols. Thus, the user interface 18 need not be physically coupled with the housing 24.

The user interface 18 may comprise one or more functionable inputs 28 such as buttons, switches, scroll wheels, etc, a touch screen associated with the display 20, voice recognition elements such as a microphone 30, pointing devices such as mice, touchpads, trackballs, styluses, combinations thereof, etc. Further, the user interface 18 may comprise wired or wireless data transfer elements such as removable memory including the memory 16, network connections, data transceivers, etc, to enable the user and other devices or parties to remotely interface with the device 10.

The user interface 18 is preferably operable to provide various information to the user utilizing the display 20 or other visual or audio elements such as a speaker. Thus, the user interface 18 enables the user and device 10 to exchange information relating to the device 10, including configuration, security information, preferences, route information, points of interests, alerts and alert notification, navigation information, waypoints, a destination address, etc.

The display 20 is coupled with the processor 12 and/or other device 10 elements and is operable to display various information corresponding to the device 10, such as maps, locations, and security information as is described below. The display 20 may comprise conventional black and white, monochrome, or color display elements including CRT and LCD devices. Preferably, the display 20 is of sufficient size to enable the user to easily view the display 20 to receive presented information while in transit. Further, as described above, the display 20 may comprise a portion of the user interface 18, such as in embodiments where the display 20 is a touch-screen display to enable the user to interact with the display 20 by touching or pointing at display areas to provide information to the device 10. In some embodiments the touch-screen display provided by the display 20 is operable to receive a fingerprint, or other biometric information, for utilization by the processor 12 with the security features discussed below.

The power source 22 is associated with the housing 24 to provide electrical power to various device 10 elements. For example, the power source 22 is preferably directly or indirectly coupled with the user interface 18, location determining component 14, processor 12, memory 16, and/or display 20. The power source 22 may comprise conventional power supply elements, such as batteries, battery packs, etc. The power source 22 may also comprise power conduits, connectors, and receptacles operable to receive batteries, battery connectors, or power cables. For example, the power source 22 may include both a battery to enable portable operation and a power input for receiving power from an external source such an automobile.

The housing 24 is preferably handheld or otherwise portable to facilitate transport of the device 10 between locations. Preferably, the housing 24 is suitable for mounting or coupling with an automobile to enable the device 10 to be utilized while in transit. Thus, the housing 24 may be configured for mounting within or on an automobile in a generally conventional manner and may comprise generally conventional and durable materials, such as ABS, plastics, metals, etc, to protect the enclosed and associated elements.

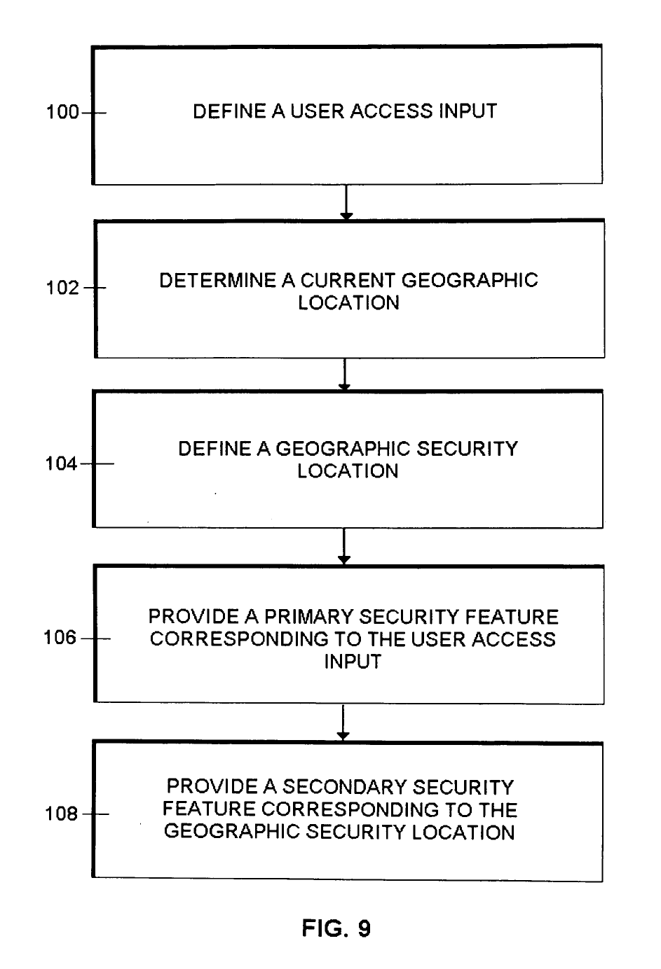

Steps 100-108 shown in FIG. 9 generally illustrate the preferred operation of the device 10 which generally includes the steps of: (a) defining a user access input, referenced at step 100; (b) determining a current geographic location, referenced at step 102; (c) defining a geographic security location, referenced at step 104; (d) providing a primary security feature corresponding to the user access input, referenced at step 106; and (e) providing a secondary security feature corresponding to the geographic security location, referenced at step 108.

The method described herein may be utilized manually by a user or in combination with any device such that utilization of the device 10 is not necessarily required. Additionally, steps 100-108 may be performed in any order and are not limited to the specific order described herein. Further, steps 100-108 may be performed simultaneously or concurrently such that the steps are not necessarily sequential.

In step 100, the user access input is defined. Preferably, a user defines the user access input utilizing the user interface 18 and the user access input is stored within the memory 16 for later use in step 106. As is discussed in more detail below, the user access input is entered by the user to satisfy the primary security feature and enable full use of the device 10. Thus, the user access input generally corresponds to a password, such as a PIN, fingerprint, voice command, other biometric input, digital information, hardware key, combinations thereof, or any other input operable to be provided by the user through the user interface 18.

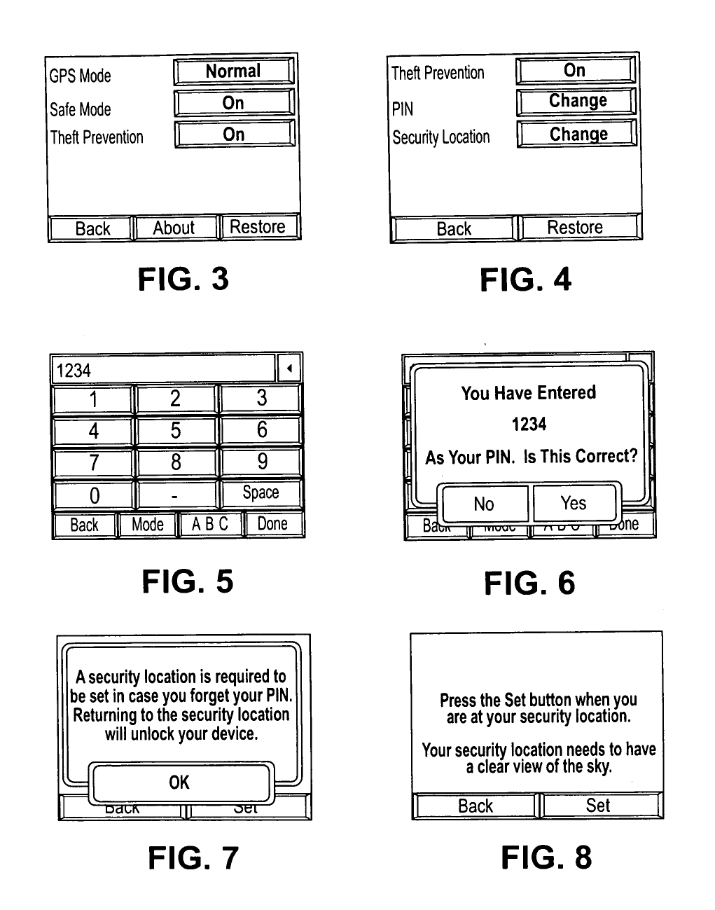

FIGS. 3-6 provide exemplary screen displays illustrating the general method for defining the user access input. As shown in FIGS. 3-4, a user may navigate through one or more menus utilizing the user interface 18 to active the primary security feature and input the user access input. As shown in FIGS. 5-6, the user may utilize the user interface 18 to define the user access input and the device 10 may provide confirmation of the defined user access input. For instance, as shown in the example of FIG. 5 the user may utilize the user interface 18 to enter a PIN as “1234.” The user access input is then preferably stored within the memory 16 to enable its utilization in later steps.

In various embodiments, the user functions one or more of the functionable inputs 28 to define the user access input. For example, the user may type the user access input, such as a password or PIN, utilizing the functionable inputs 28 and/or utilize the functionable inputs 28 to select appropriate characters displayed on the display 20. For instance, the user may depress a first input to cycle through a list of characters and depress a second input to select one of the characters as part of the user access input.

The user may also function the display 20 to define the user access input. For example, in embodiments where the display 20 includes a touch screen, the user may touch portions of the display to enter a PIN or password as shown in FIG. 5. In embodiments where the display 20 is operable to read fingerprints, the user may touch portions of the display to store his or her fingerprint as the user access input. As should be appreciated, the user interface 18 may be operable to record other biometric information as the user access input and need not be limited to fingerprints.

The user may also utilize the microphone 30 to provide a voice command to be utilized as the user access input. For example, the microphone 30 may record the user's speech and store the recorded speech in the memory 16 for utilization in step 106. The user may function one or more of the functionable inputs 28 or the display 20 to select what speech is to be utilized as the user access input.

The user may also utilize a hardware key to provide digital information through the user interface 18 to define the user access input. For example, the user may insert a removable memory card into the slot 26 that includes digital information, such as a digital password, PIN, encrypted file, identifying data, etc. The digital information provided by the removable memory card may then be stored within the memory 16 for later comparison in step 106.

Alternatively, the digital information utilized as the user access input may be predefined and previously stored within the memory 16 or processor 12 such that the user need not insert the removable memory card to define the user access input. For example, the user may be provided with a removable memory card when purchasing the device 10 to utilize as the user access input.

The user may also utilize a hardware key that the user programs to unlock the device. For example, the user may acquire a blank key, insert the key into the slot 26, and function the user interface 18 in order to instruct the device 10 to program the key with identifying information, such as a unit ID and/or serial number. Thereafter, the key may be reinserted into the slot 26 to unlock the device 10.

The user may also utilize a physical key as the user access input. Specifically, the slot 26 may be configured to receive a particular key as an input and the user may provide the particular key instead of or in addition to other inputs, such as a PIN. The key may be any element having physical identifying features, including a conventional key having slots and grooves or any other unique physical element. In a similar manner to the removable memory card discussed above, the user may be provided with the key when purchasing the device 10 to utilize as the user access input.

As should be appreciated, various combinations and variations of the above may be employed to define the user access input. For instance, a combination of a PIN and a fingerprint may be required, etc. Thus, the user access input is not limited to the inputs expressly discussed above. Further, step 100 is not necessarily performed in all embodiments as the primary security feature, discussed below, may correspond to any user input.

In step 102, the device 10 determines its current geographic location. As described above in detail, the processor 12 and/or the location determining component 14 may determine the current geographic location of the device 10 utilizing GPS signals or other location determining methods, including signal triangulation. The determined current geographic location is preferably at least temporarily stored within the memory 16 for use by the processor 12 and other device 10 elements.

The device 10 may additionally determine its current geographic location by acquiring its current geographic location from another device or the user. For example, in some embodiments the location determining component 14 may determine the current geographic location utilizing the user interface 18, such as by receiving the current geographic location from the user, through a network, from another electronic device, etc. Thus, the device 10 is not necessarily required to independently determine its current geographic location.

Step 102 is preferably continuously repeated to enable the current geographic location of the device 10 to be continuously ascertained. Thus, step 102 may be performed concurrently or simultaneously with the other steps described herein.

In step 104, the geographic security location is defined. The geographic security location represents a location or area specific to each user operable to be utilized by the device in step 106 to provide additional security features. For example, the user may select his or her driveway, workplace parking lot, favorite restaurant parking lot, local landmark, a local police station, etc, as the geographic security location. Utilization of specific and special locations as the geographic security location enables the location to be easily remembered by the user.

Preferably, the user defines the geographic security location utilizing the user interface 18 and the current geographic location of the device 10. For example, FIG. 7 provides an exemplary screen display providing general information concerning the security location and FIG. 8 provides an exemplary screen display instructing the user to indicate when they have arrived at the security location.

To define the geographic security location, the user may transport the device 10, such as by driving his or her automobile, to the geographic security location and function the user interface 18, such as by depressing one of the functionable inputs 28, by issuing a voice command, etc. Upon functioning the user interface 18, the device 10 stores the current geographic location of the device 10, as determined in step 102, in the memory 16 as the geographic security location for later comparison.

In various embodiments, the device 10 is operable to define a plurality of geographic security locations by repeating the general method discussed above. Thus, the user may travel to various locations and function the user interface 18 at each location to define each location as a geographic security location. Similarly, step 104 may be repeated in some situations, such as where the primary security feature is satisfied, to redefine the geographic security location. Further, step 104 is not necessarily preformed in all embodiments, as the secondary security feature, discussed below, may correspond to any location.

In step 106, the device 10 provides the primary security feature corresponding to a user input, such as the user access input. Preferably, the primary security feature requires the user to provide the user access input each time the device 10 is powered on. Full access to the device, such as access to navigation, communication, or entertainment functions, is preferably denied or at least limited until the user provides the user access input through the user interface 18. After providing the user access input, all features of the device 10 are rendered fully-functional and the user access input need not be entered again until the device is powered off and back on again.

The device 10 is operable to compare or process the user input provided through the user interface 18 to determine if the user input corresponds to the user access input. For example, the user may enter a PIN, password, voice command, fingerprint, digital information, physical key, etc., utilizing the user interface 18 and the processor 12 compares the entered user input to the user access input stored within the memory 16. Should the current user input and the stored user access input correspond, the primary security feature is satisfied.

For example, if the PIN “1234” is stored within the memory 16 in step 100 as the user access input, each time the device 10 is powered on, the PIN “1234” must be entered utilizing user interface 18 to satisfy the primary security feature and enable all device features.

In embodiments where the user access input corresponds to digital information, the digital information provided through the slot 26 or other portions of the user interface 18 is compared to information stored within the memory 16 or otherwise retained by the processor 12 to determine if the provided digital information corresponds to the user access input 12. For example, the device 10 may include a predetermined ten-digit user access input that is stored within the memory 16 or included within the processor 12. In such an embodiment, the processor 12 is operable to compare a ten-digit number provided through the user interface 18, such as through the slot 26, to the pre-determined user access input number to determine if the primary security feature is satisfied.

Similarly, in embodiments where the user access input corresponds to a physical key, the device 10 is operable to determine if a key inserted into the slot 26 by the user corresponds to the user access input by utilizing conventional electrical or mechanical elements. If the inserted key corresponds to the user access input, the primary security feature is satisfied.

Step 106 is not necessarily limited to the comparison of user inputs to the user access input, as the processor 12 may utilize user inputs independent of the user access input to determine if the primary security feature is satisfied.

In step 108, the device 10 provides a secondary security feature corresponding to the geographic security location. The secondary security feature is preferably satisfied by comparing the current geographic location to the geographic security location. For example, the secondary security feature may be satisfied when the current geographic location of the device 10, as determined in step 102, is in proximity to the geographic security location.

The current geographic location is in proximity to the geographic security location when the current geographic location and the geographic security location are within approximately one hundred meters of each other. Preferably, the current geographic location is in proximity to the geographic security location when the current geographic location and the geographic security location are within approximately fifty meters of each other.

Utilizing of a fifty-meter proximity distance provides a margin of error that enables satisfaction of the secondary security feature even when the device 10 is unable to precisely determine its current geographic location or where the user does not know exactly where the device 10 was positioned when the geographic security location was defined. For instance, the user may remember the parking lot corresponding to the geographic security location but not remember the exact parking space he or she was parked in when the geographic security location was defined.

Additionally, a distance of approximately fifty meters is specific enough that a thief randomly selecting locations would not easily locate the geographic security location and satisfy the secondary security feature. However, as should be appreciated, any distance or range between the geographic security location and the current geographic location may be utilized, in specific applications, including ranges less than fifty meters and ranges greater than one hundred meters.

In various embodiments, the secondary security feature is only satisfied when the current geographic location corresponds to the geographic security location for a predetermined amount of time. For example, the processor 12 may require the current geographic location to be in proximity to the geographic security location for at least thirty seconds. Such a configuration prevents a thief from rapidly and randomly traveling through locations to locate the geographic security location. Similarly, the processor 12 may require that the user function the user interface 18 at the geographic security location to satisfy the secondary security feature to further deter thieves from attempting to locate the geographic security location.

The secondary security feature need not necessarily utilize or otherwise correspond to the geographic security location. For example, the memory 16 may include one or more user-selected or pre-determined locations or ranges, other than the geographic security location, to which the current geographic location of the device may be compared. Also, the secondary feature may utilize data related to or associated with the current geographic location, such as access parameters associated with particular locations or allowed functions associated with particular locations, instead of directly comparing the current geographic location to a previous geographic location or the geographic security location.

The secondary security feature may function in a similar manner to the primary security feature. For example, the various functions of the device 10 may be inoperable until the current location of the device 10 is in proximity to the geographic security location. Thus, in some embodiments, to render the device 10 fully operational, the user would be required to provide the user access input, such as a PIN, and position the device 10 in proximity to the geographic security location.

However, satisfaction of the secondary security feature is preferably not required to render the device 10 fully functional. Preferably, the secondary security feature is operable to override the primary security feature to enable the user to reset and/or redefine the user access input, such as a PIN, should the user forget the content of the user access input.

For instance, should the user forget the user access input required to satisfy the primary security feature, the user may transport the device 10 in proximity to the geographic security location to satisfy the secondary security feature and override the primary security feature. Upon overriding the primary security feature, the user may provide a new input, utilizing the user interface 18, to define the user access input in a substantially similar manner to that described in step 100.

As the geographic security location is likely easier for the user to remember than a PIN or other potentially complicated user access input, the user is provided with a convenient and easy way to reset the user access input that may not be easily circumvented by a thief.

Thus, in preferred embodiments, the user initially defines the user access input in step 100 and the geographic security location in step 102, as shown in FIGS. 3-8. The user enters the user access input each time the device 10 is powered on to enable all functionality provided by the device 10 regardless of its current geographic location. Should the user ever forget or otherwise lose the user access input, including situations where the user access input is corrupted within the memory 16, the user may merely return to a location in proximity to the geographic security location, thereby unlocking full functionality, and allowing the user to redefine the user access input. It should be noted that once the user returns the device 10 to the geographic security location, the device 10 is restored to full functionality regardless of its current geographic location until the device 10 is powered off.

Although the invention has been described with reference to the preferred embodiment illustrated in the attached drawing figures, it is noted that equivalents may be employed and substitutions made herein without departing from the scope of the invention as recited in the claims.

For example, rather than using the geographic security location as a secondary security feature, as described herein, the geographic security location could be used as the primary security feature or even solitary security feature. More specifically, if the device 10 is powered on at the security location, such as the user's driveway, the geographic security location security feature could be automatically satisfied in the background without interfering with the user's use of the device 10. If, however, the device 10 is not powered on at the security location, the device 10 may prompt the user for the user access input.

Alternatively, the device 10 may randomly or periodically seek satisfaction of one of the security features. For example, the user may select a security location that they frequently visit, such as home, work, church, or school. Then, the user may select a frequency that they expect to visit that security location, such as daily, weekly, or monthly. The device 10 may track the user's movements and automatically reset a timer, counter, or other tracking function each time the device 10 comes in proximity to the security location. If the device 10 has not come in proximity to the security location within the selected frequency, the device 10 may prompt the user for satisfaction of any of the security features discussed above. Selection or modification of this security location and/or frequency can be protected by any of the security features discussed above.

In this manner, the security features protect the device 10 from theft without inconveniencing the user. Specifically, as long as the user maintains their normal schedule, the device 10 automatically confirms the security location in the background, without interfering with the user's use of the device 10. However, should the device 10 become stolen, the thief will almost certainly not even know to attempt to maintain the user's normal schedule and will therefore fail to visit the security location within the selected frequency. Thus, while the user is never inconvenienced, the thief will be prompted to satisfy one of the security features before being permitted to use the device 10. To remind the user and/or deter the thief, upon being powered on, the device 10 could also display a count down, displaying the number of days remaining before a security feature must be satisfied.

Furthermore, while it is envisioned that virtually all of the device's 10 useful features will be disabled before one of the security features is satisfied, the security features could be used to protect only a portion of the device's 10 functionality. For example, the device 10 may store the user's personal information, which can be made inaccessible or otherwise protected by any one of the security features.

Finally, while it is envisioned that the device 10 will use its location determining component 14 to facilitate the security location functionality, the user interface 18 could be used instead. For example, the user could pan through a map displayed on the display 20 and select a displayed location as the security location. Alternatively, the user could enter a latitude and longitude, or some other set of coordinates, to select the security location. Additionally, or alternatively, particularly where the user is far from their security location, the user could satisfy the security location functionality by selecting the security location from the displayed map.

In this regard, as discussed above, the device 10 need not incorporate the location determining component 14 at all. Thus, the device 10 could alternatively be a simple map displaying apparatus, such as a chart plotter or even a web site.

Having thus described the preferred embodiment of the invention, what is claimed as new and desired to be protected by Letters Patent includes the following:

1. A method of securing an electronic device, the method comprising the steps of:
providing a primary security feature corresponding to a user input;
providing a secondary security feature corresponding to a geographic security location; and
preventing access to functionality within the device if neither security feature is satisfied, such that the device is fully functional after either security feature is satisfied.

2. The method of claim 1, further including the step of defining a user access input, wherein the primary security feature is satisfied when the user input corresponds to the user access input.

3. The method of claim 1, wherein the secondary security feature is operable to override the primary security feature.

4. (canceled)

5. The method of claim 1, wherein the secondary security feature is satisfied when a current geographic location of the electronic device is in proximity to the geographic security location.

6. The method of claim 1, wherein the user input is selected from the group consisting of a PIN, a fingerprint, a voice command, digital information, a physical key, and combinations thereof.

7. An electronic device comprising:
a location determining component operable to determine a current geographic location of the electronic device;
a user interface operable to receive a user input; and
a processor coupled with the location determining component and the user interface, the processor operable to—
provide a primary security feature corresponding to the user input,
provide a secondary security feature corresponding to a geographic security location,
decide whether either security feature is satisfied, and
prevent access to functionality within the device if neither security feature is satisfied, such that the device is fully functional after either security feature is satisfied.

8. The electronic device of claim 7, wherein the user interface is further operable to receive a user access input and the primary security feature is satisfied when the user input corresponds to the user access input.

9. The electronic device of claim 7, wherein the secondary security feature is operable to override the primary security feature.

10. (canceled)

11. The electronic device of claim 7, wherein the processor defines the geographic security location utilizing the current geographic location of the electronic device.

12. The electronic device of claim 7, wherein the secondary security feature is satisfied when the current geographic location of the electronic device is in proximity to the geographic security location.

13. The electronic device of claim 7, further including a memory coupled with the processor and operable to store the geographic security location.

14. The electronic device of claim 7, wherein the user interface includes a functionable input and the user input corresponds to a PIN.

15. The electronic device of claim 7, wherein the user interface includes a touch-screen display and the user input corresponds to a fingerprint.

16. The electronic device of claim 7, wherein the user interface includes a microphone and the user input corresponds to a voice command.

17. The electronic device of claim 7, wherein the user interface includes a slot operable to receive a digital memory element and the user input corresponds to digital information.

18. The electronic device of claim 7, wherein the user interface includes a slot operable to receive a key and the user input corresponds to insertion of the key into the slot.

19. A navigation device comprising:
a location determining component operable to determine a current geographic location of the navigation device;
a user interface operable to receive a user input;
a memory;
a processor coupled with the location determining component, the user interface, and the memory, the processor operable to—
provide a primary security feature corresponding to the user input,
define a geographic security location and store the geographic security location within the memory, and
provide a secondary security feature corresponding to the geographic security location, the secondary security feature operable to override the primary security feature when the current geographic location of the navigation device is in proximity to the geographic security location.

20-26. (canceled)

27. A method of securing an electronic device, the method comprising the steps of:
locking functionality of the electronic device;
providing a primary security feature;
providing a secondary security feature, wherein the secondary security feature is different from the primary security feature, and wherein both security features are selected from the group consisting of a security location, a password, a PIN, a fingerprint, a voice command, an electronically encoded hardware key, and a physically encoded hardware key;
unlocking the functionality of the electronic device once either security feature has been satisfied; and
wherein the above steps are performed within the electronic device itself.

28. The method of claim 27, wherein the functionality includes a routing capability that calculates and presents a route from a current geographic location to a desired geographic location.

29. The method of claim 27, wherein one of the security features corresponds to the security location.

30. The method of claim 29, wherein the security location based security feature operates in the background if periodically satisfied.

31. The method of claim 1, further including the step of deciding, within the device, whether either security feature is satisfied.

32. A method of securing an electronic device, the method comprising the steps of:
monitoring a current location of the electronic device;
comparing the current location with a geographic security location;
resetting a timer when the current location corresponds to the geographic security location;
preventing access to functionality within the device when the timer expires;
prompting a user to satisfy a security feature; and
providing access to functionality within the device when the user satisfies the security feature.

33. The method of claim 32, wherein the security feature is selected from the group consisting of a password, a PIN, a fingerprint, a voice command, an electronically encoded hardware key, and a physically encoded hardware key.

34. The method of claim 32, wherein the monitoring, comparing, resetting, preventing, prompting, and providing steps are all performed by a processor housed in a housing of the electronic device.

35. The method of claim 32, further including the step of resetting the timer when the user satisfies the secondary security feature.

36. The method of claim 32, wherein the functionality includes a routing capability that calculates and presents a route from the current location to a desired location.

37. The method of claim 32, wherein the geographic security location is defined utilizing the current location of the electronic device.

38. The method of claim 32, wherein the security feature is satisfied when the current location is in proximity to the geographic security location.

39. The method of claim 32, wherein the security feature is unrelated to the geographic security location.
